(19) United States
(12) Patent Application Publication
(10) Pub. No.: US 2015/0200893 A1
(43) Pub. Date: Jul. 16, 2015

(54) DOCUMENT REVIEW SYSTEM

(71) Applicants: Jeff Harris, New York, NY (US); Yiyang Joy Ding, Brooklyn, NY (US); Jonathan Rochelle, Chester, NJ (US)

(72) Inventors: Jeff Harris, New York, NY (US); Yiyang Joy Ding, Brooklyn, NY (US); Jonathan Rochelle, Chester, NJ (US)

(73) Assignee: Google Inc., Mountain View, CA (US)

(21) Appl. No.: 13/614,322

(22) Filed: Sep. 13, 2012

(51) Int. Cl. H04L 12/58; H04L 29/06

(52) U.S. Cl. CPC H04L 51/16; H04L 65/403

(57) ABSTRACT

In response to a user request, a server identifies and facilitates communication with a third-party collaborator who may not be known to the user. Potential collaborators are identified by familiarity with a subject matter of a document or user request. The potential third-party collaborator is allowed to see the context of the user request, and the user may ask a third-party collaborator a follow-up question.

### BACKGROUND

Collaboration is often helpful in drafting media, including documents, presentations, spreadsheets, images, and other productions. Even if a document drafter is intimately familiar with every topic broached in the document, the drafter cannot know how other people will interpret the writing without asking them. Collaboration tools are thus a key feature of applications for producing media. Such applications generally offer the ability to track how different users edited a file, allowing the users to readily identify which parts of their file require revision. But collaborating in standalone programs can make collaboration unwieldy. A user must wait for collaborators to send a file to see the latest edits to and comments on the file, and as a collaborative group grows in size, it becomes increasingly difficult to be sure that a given version is the most up-to-date file available.

Web applications improve on standalone programs in part by allowing real-time collaboration. An online word processor like Google Docs stores documents on a server, providing the latest version to users accessing the document and updating the version as users edit the document. Multiple users can therefore edit a document at the same time, allowing real-time collaboration even when the collaborators are geographically dispersed. But web applications, like standalone applications, require users to independently identify collaborators.

The collaboration features of modern file-generating applications are only useful when a user knows an appropriate collaborator. Users must know a collaborator before they can provide access to the collaborator, whether that access is provided by transmitting a file or an Internet link. But the less familiar a subject is to a user, the less likely the user is to know the people who would provide the most useful collaboration regarding the subject. Word processors currently in use, whether web-based or not, cannot identify possible collaborators and request their assistance with a limited portion of a document.

Therefore there is a need for file-generating applications which can efficiently find collaborators.

### SUMMARY

Accordingly, the systems and methods described herein relate to identifying and communicating with potential collaborators. By identifying the subject of a document and the nature of the need for assistance, the systems and methods described herein may identify potential collaborators who are well-positioned to offer the assistance the user needs but need not be known to the user. Moreover, the systems and methods described herein can restrict collaborator access to those parts of the document relevant to the user need for assistance.

It is a realization of the inventors that outside collaborators are most helpful when they know the context in which the need for help arose. Consequently, the systems and methods described herein relate to, in one aspect, a system for identifying a collaborator, providing the collaborator with a portion of the document related to the user collaboration request, and receiving a response from the collaborator.

In certain embodiments, the system described herein relates to identifying and collaborating with third-party collaborators. The system includes a user database, a document processor, a document database, a request identification processor, a natural language processor, and a message processor. The user database stores at least one user permitted to edit a document, which is displayed by the document engine and stored by the document database. In certain embodiments, the user database may also store a membership of a user in a group, a collaborator rating of a user, expertise of a user in a subject matter, some other information regarding the user as a collaborator, or some combination thereof. In some embodiments in which the user database stores a user expertise, expertise may be determined by a subject matter of a document the user is authorized to edit. The request identification processor identifies a user request for collaboration and a portion of the document associated with the request. The natural language processor identifies a request subject matter associated with the user request and a document subject matter associated with the document. The document subject matter is also stored in the document database. The message processor identifies a candidate pool of at least one receiving collaborator based on at least one of the request subject matter and the document subject matter. In certain embodiments, the candidate pool is further based on membership in at least one group of at least one user permitted to edit the document, a collaborator rating, or other suitable identifying information. The message processor generates a message related to the user request and sends the message to at least one receiving collaborator in the candidate pool. In response to at least one responding collaborator responding to the message, the message processor grants the at least one responding collaborator access to the portion of the document associated with the request. The message processor further receives a response from a responding collaborator and provides the response to the requesting user, in certain embodiments by embedding the response within the document. In certain embodiments, the message processor may change a collaborator rating based on a user reply to the collaborator response. In certain embodiments, the message processor may also rescind collaborator access in response to a predetermined criteria, which may include a user action or, in embodiments in which the system includes a timer, in response to the passage of a predetermined length of time.

According to another aspect, the method described herein identifies and requests assistance from third-party collaborators. In certain embodiments, the method may include providing, at a server, a document generated by at least one user and having content including a document subject matter. The server receives a request from the at least one user, the request having a request subject matter, and identifies at least one of the document subject matter and the request subject matter. The server may use at least one of the document subject matter and the request subject matter as the basis for identifying a candidate pool of at least one receiving collaborator, such as by comparing at least one of the document subject matter and the request subject with one or more documents generated by one or more receiving collaborators. In certain embodiments, the server may restrict the candidate pool to members of a group of the at least one user. In certain embodiments, identification information for the candidate pool is received from the at least one user. The server sends a message related to the request to at least one receiving collaborator in the candidate pool, in some embodiments including the user request in the message. In response to at least one responding collaborator responding to the message, which may include following an Internet link, the server grants the at least one responding collaborator access to a portion of the document. In certain embodiments, the responding collaborator may be a receiving collaborator, or may be outside the candidate pool. In certain embodiments, the server may rescind collaborator access to the document, such as when a predetermined length of time has passed, when the collaborator provides a response, or under some other suitable condition. The server receives a response from a responding collaborator and sends the response to the at least one user, in certain embodiments by embedding the response within the document and providing the document to the user. In certain embodiments, the server may receive a user rating of the response. In such embodiments, the candidate pool may be determined by the ratings the user has received for a response.

### BRIEF DESCRIPTION OF THE DRAWINGS

The systems and methods described herein are set forth in the appended claims. However, for the purpose of explanation, several embodiments are set forth in the following figures.

FIG. 1 is a block diagram of a collaboration system, according to an illustrative embodiment;

FIG. 2 is a block diagram of a collaborator identification and communication system, according to an illustrative embodiment;

FIG. 3A-F depict exemplary screenshots of a user requesting collaboration, a collaborator providing collaboration, the user receiving the collaboration, and the user accepting or rejecting the collaboration, respectively, as rendered by the collaboration system of FIG. 2;

FIG. 4 is a flow chart of a process for identifying and communicating with a collaborator, according to an illustrative embodiment; and

FIG. 5 is a block diagram of a computing device for performing any of the processes described herein.

### DETAILED DESCRIPTION

In the following description, numerous details are set forth for the purpose of explanation. However, one of ordinary skill in the art will realize that the embodiments described herein may be practiced without the use of these specific details and that the embodiments described herein may be modified, supplemented, or otherwise altered without departing from the scope of the invention.

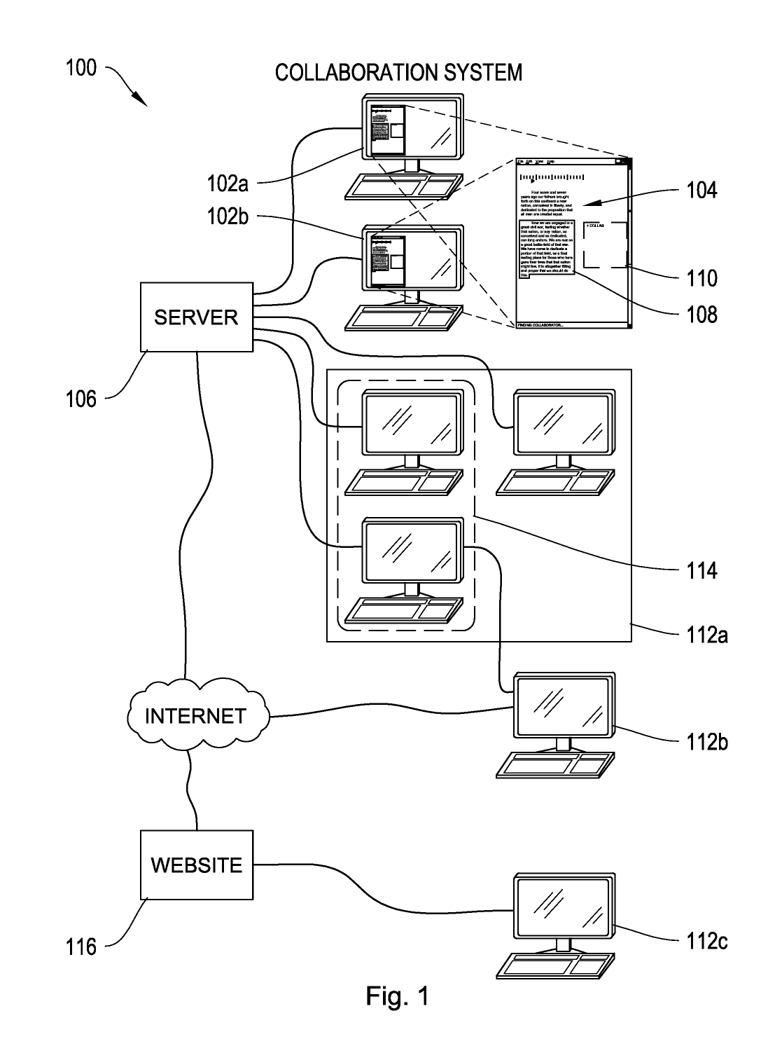

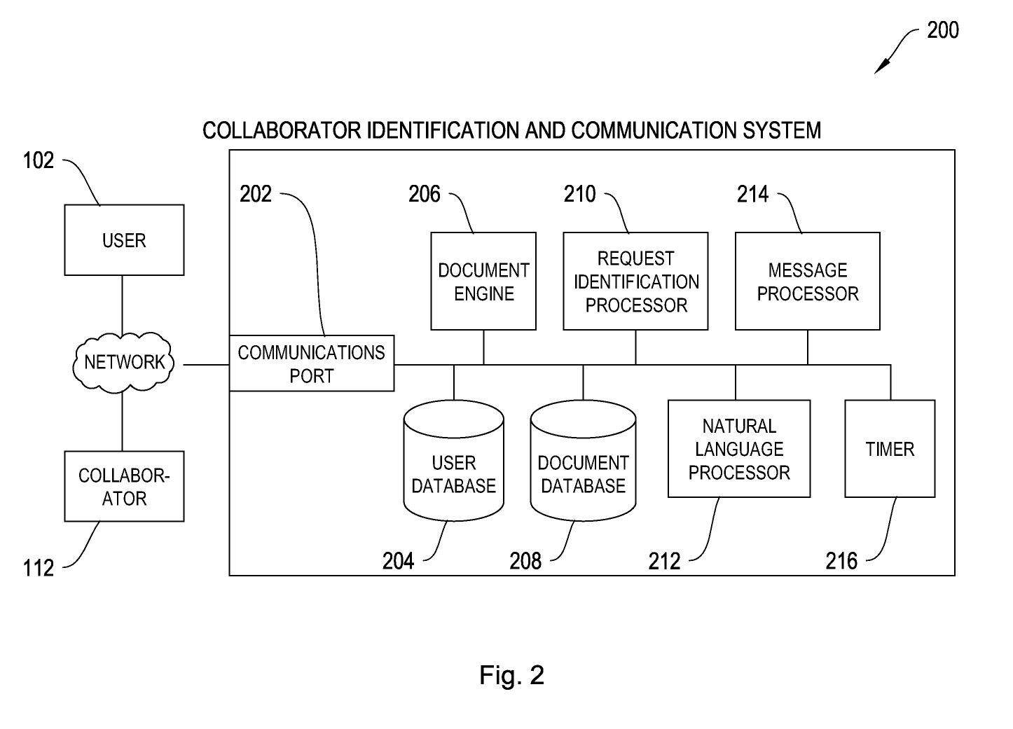

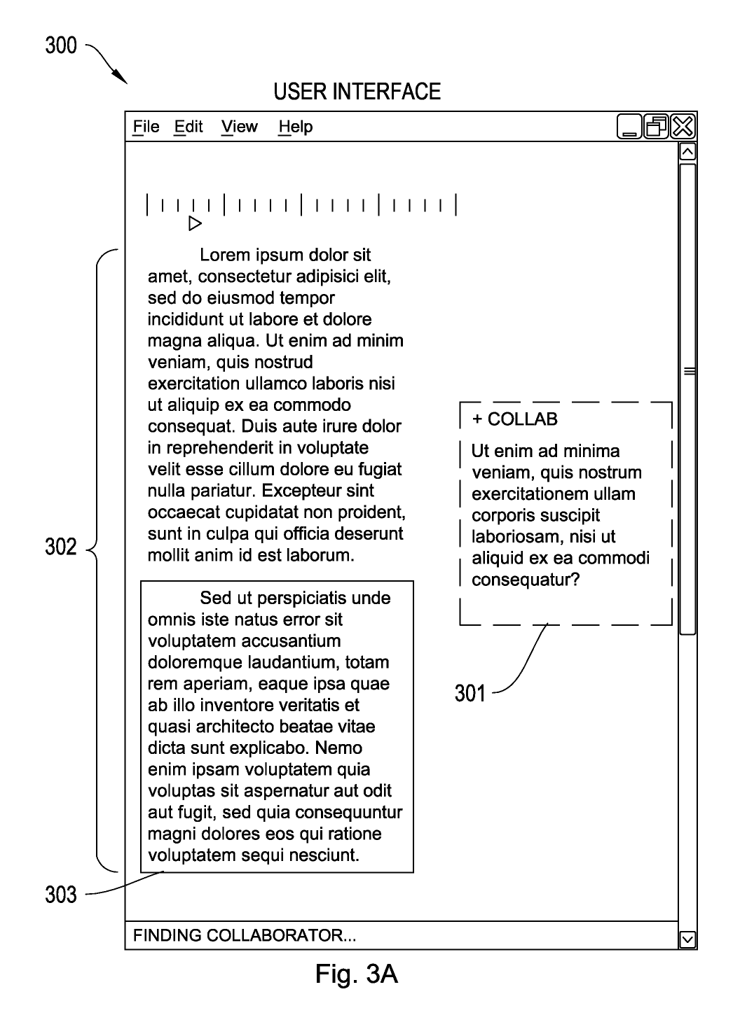

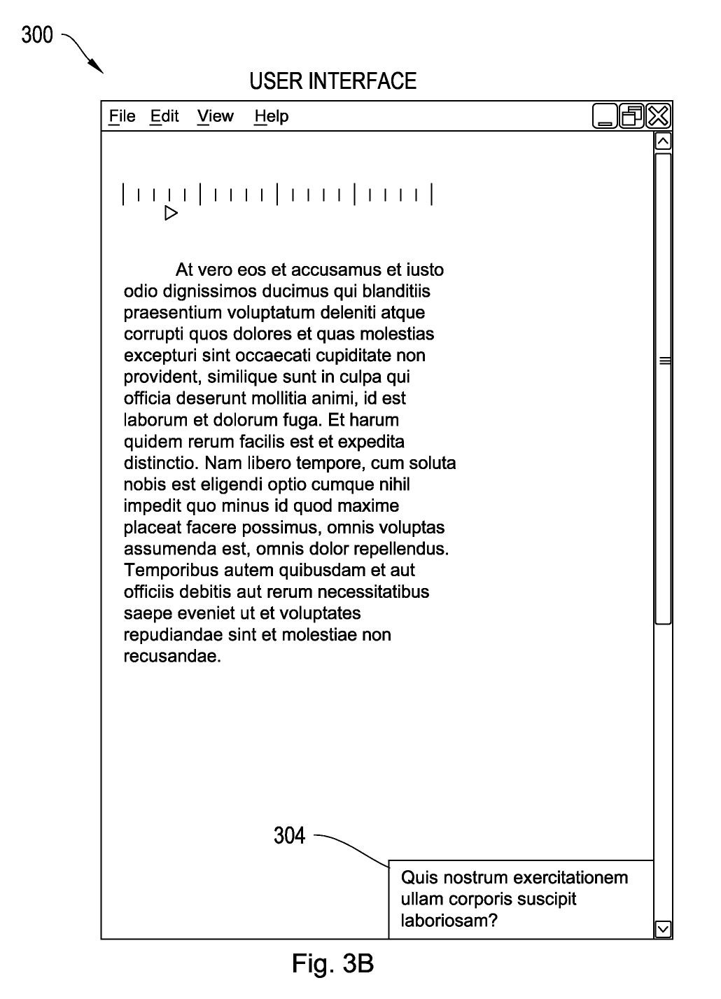

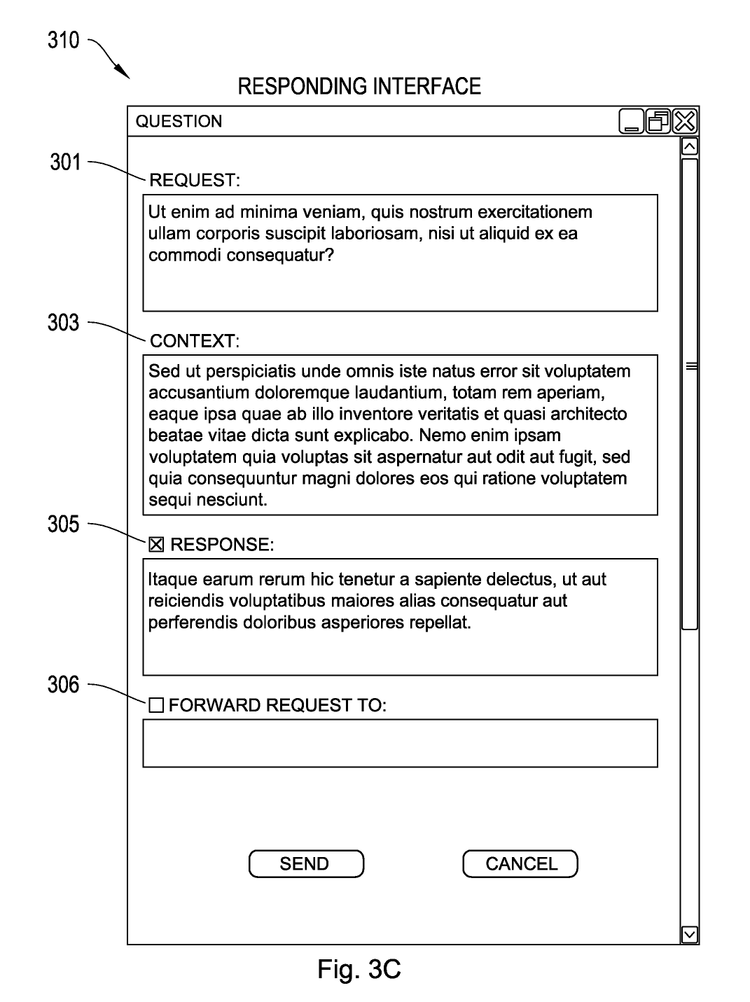

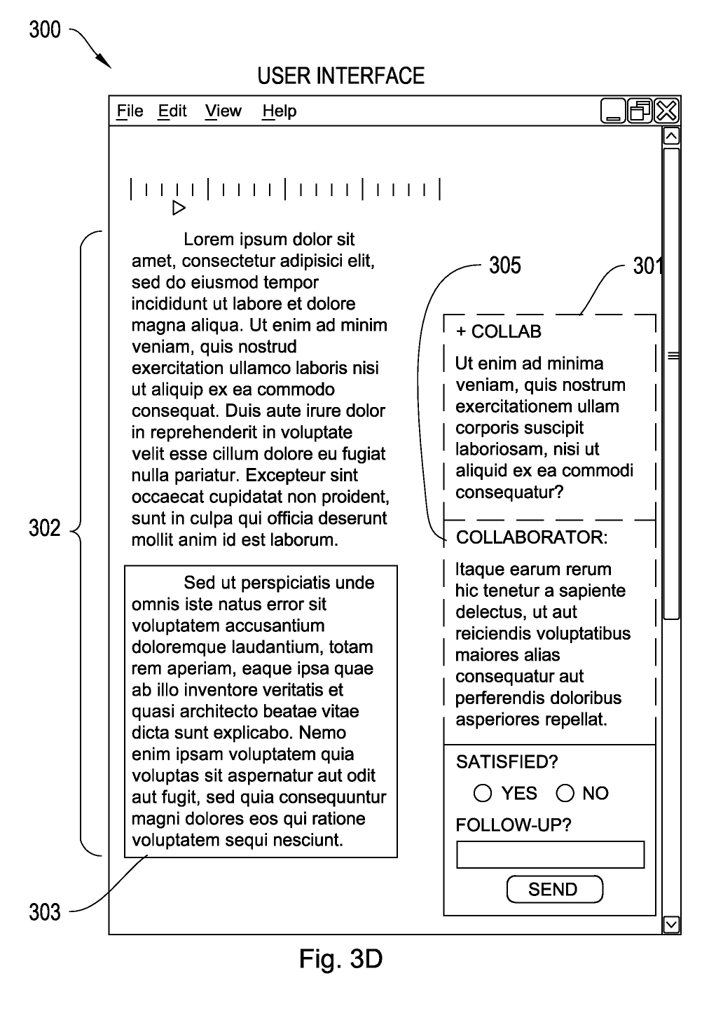

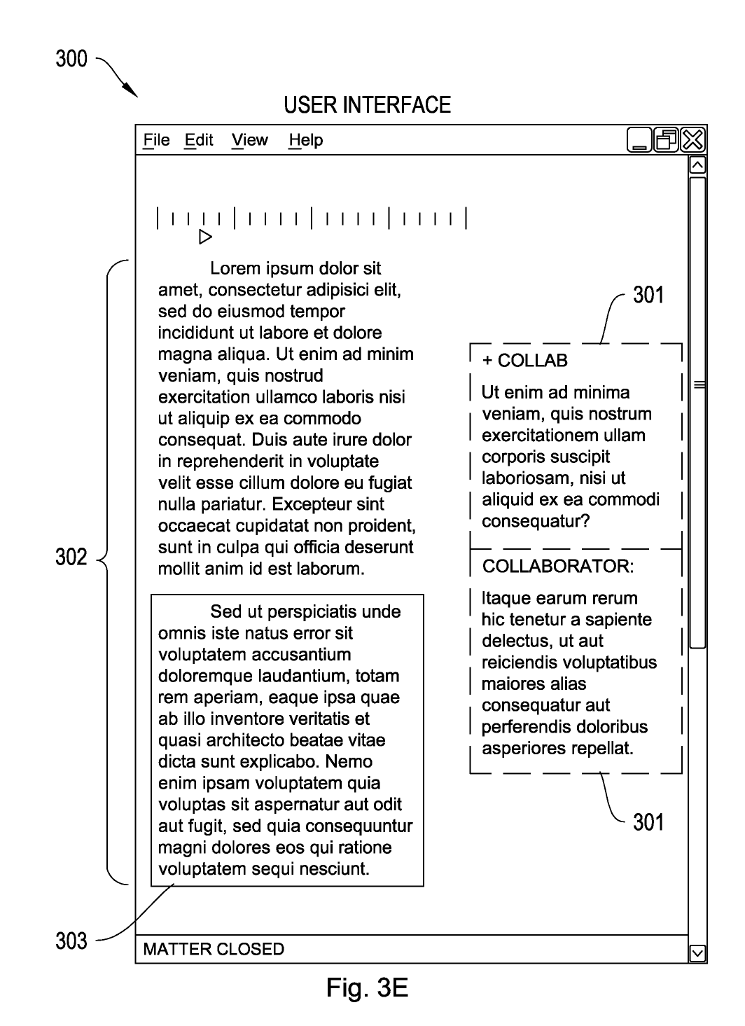

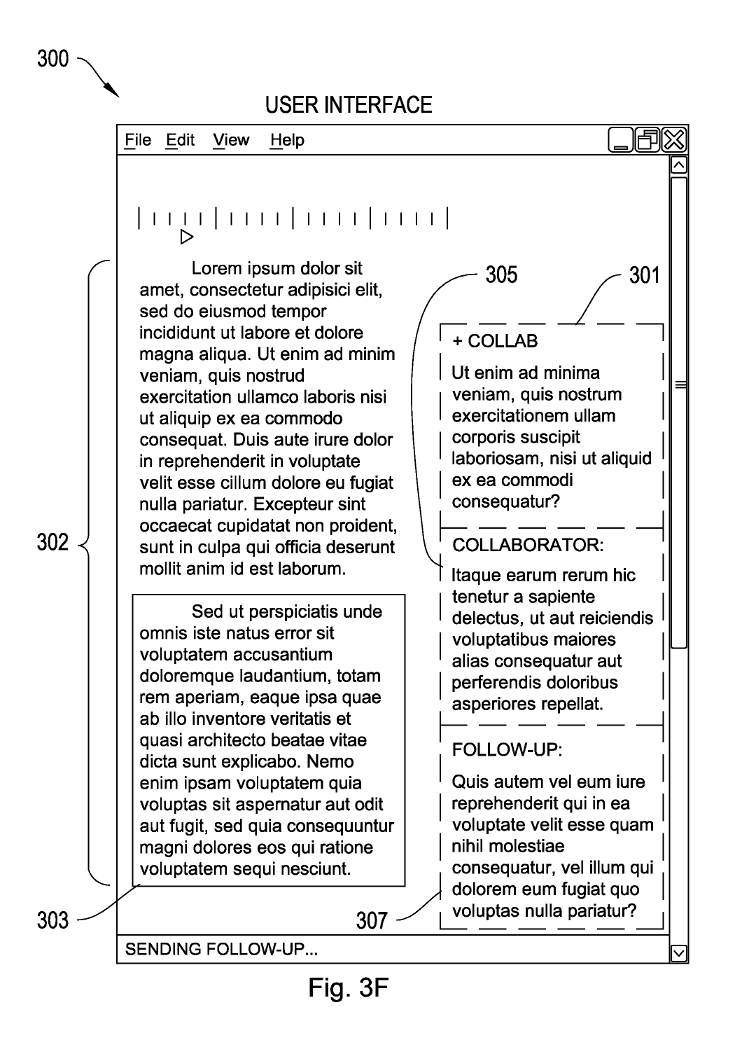

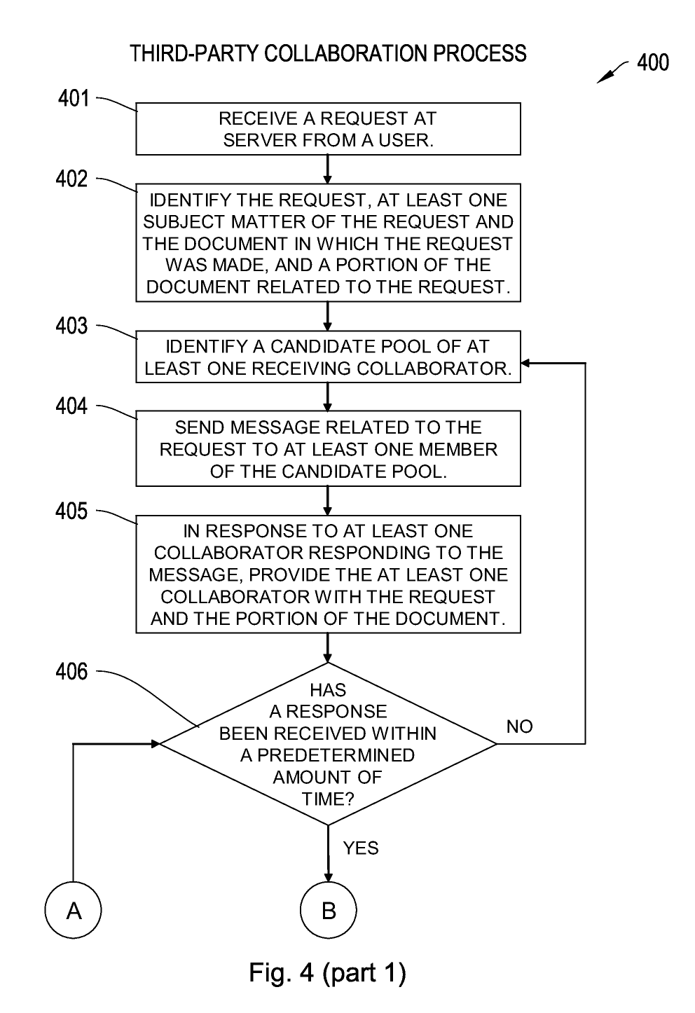

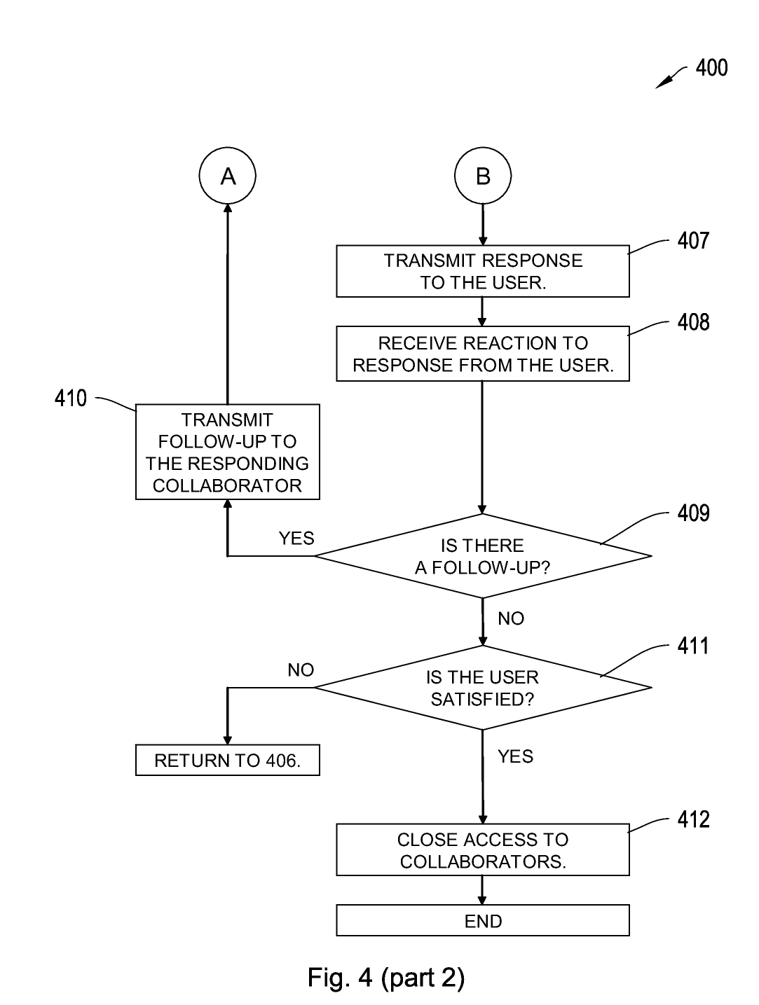

The systems and methods described herein relate to identifying and communicating with potential collaborators. In response to a user request, a server identifies at least one potential collaborator on the basis of at least one of the subject matter of the document and of the user request. The at least one potential collaborator is allowed to see the context of the user's request, and may send a response to the user. FIG. 1 provides an overview of an exemplary system used to provide such document collaboration. FIG. 2 describes in more detail an exemplary system to identify and communicate with potential collaborators. FIG. 3A depicts an exemplary user interface in which a user searches for a collaborator. FIG. 3B depicts an exemplary user interface soliciting collaboration, and FIG. 3C depicts an exemplary user interface in which a collaborator may reply to a collaboration solicitation. FIGS. 3D-F depict exemplary user interfaces in which a user receives and responds to a message from a collaborator. FIG. 4 provides an exemplary method, according to the present disclosure, for finding and communicating with a collaborator.

### General System Description

FIG. 1 is an illustrative diagram of a collaboration system 100. Users 102a and 102b (collectively, users 102) of collaboration system 100 may use collaboration system 100 to connect with outside assistance on document 104. Document 104 is stored on server 106, which is described in detail in relation to FIG. 2 and presents all users 102 accessing document 104 with identical information. In certain embodiments, server 106 may respond to a user 102 uploading a change to document 104 by initiating a transmission of (i.e., “pushing”) the modified document 104 to other users 102. If a user 102 desires outside assistance with a portion 108 of document 104, the user 102 may make a request 110 for outside assistance. In response, server 106 establishes communication between the user 102 and at least one of collaborators 112a, 112b, and 112c (collectively, collaborators 112).

The users 102 of collaboration system 100 may include creators, readers, or editors of document 104. In certain embodiments, a user 102 may be associated with more than one document 104. Users 102 may access document 104 by connecting to server 106 through a dedicated application, an Internet browser, or another suitable application, which may operate on a personal computer, a laptop computer, a smart phone, a personal digital assistant (PDA), a tablet computer, or some other suitable computation or communication device. In certain embodiments, user 102 may access document 104 through an online document processing application, accessed through an Internet browser and implemented using, for example, Javascript downloaded from server 106. In such embodiments, the online document processing application may be responsible for both rendering a user interface, such as the interface depicted in FIG. 3A, and communicating with server 106 on the user's behalf. In certain embodiments, user 102a may be the administrator of document 104, and may grant editing privileges to other users including user 102b. In certain embodiments, there may be a different number of users 102a or 102b than are depicted. Collaboration system 100 may connect user 102 with outside assistance on a document 104.

Document 104 may be a computer file provided to server 106 by a user 102, with content which may include text, graphics, multimedia, or some combination thereof. As an illustrative example, document 104 may be an essay, a picture book, a presentation, an audio recording, a video, a spreadsheet, source code, a collection of photographs, a graph, or some other suitable file. The content may discuss or represent one or more document subject matters, which in turn may represent substantive aspects of document 104 or of portions of document 104. As an illustrative example, a presentation document featuring a series of sketches by Leonardo da Vinci may have one or more document subject matters, which may include da Vinci, the Renaissance, engineering, art history, or some combination thereof. In certain embodiments, a portion of a document 104, including a section, may include a plurality of subject matters. In certain embodiments, several portions of a document 104 may relate to a single subject matter. A subject matter or content associated with a subject matter may be determined based on context. For example, a subject matter may be identified by a heading or sub-heading of a section of document 104, and the section may be associated with the identified subject matter. A user 102 may also identify one or more subject matters. User 102 may identify the one or more subject matters by tagging one or more sections, headings, or any desired portion of document 104. User 102 may perform such tagging through one or more prompts in system 100. In certain embodiments, the tagged subject matter may be stored in metadata of document 104. A user 102 may desire assistance with one or more subject matters located in one or more portions 108 of document 104. As an illustrative example, a user 102 writing an essay explaining how slavery ended in the U.S. may desire outside assistance regarding those parts of the essay focused on the U.S. Civil War.

Portion 108 may include any part of document 104. In certain embodiments, portion 108 is a part or parts of document 104 to which request 110 relates. Portion 108 may be explicitly identified by at least one user 102, identified by server 106 through a search of document 104 for content related to the subject matter of request 110, or identified through some other suitable method. In certain embodiments, portion 108 may include two sections of content separated by a third section of content. As an illustrative example, if a user 102 makes a request 110 for advice on the introduction and conclusion of an essay, portion 108 may include the first and final paragraphs of the essay. Similarly, if request 110 regards how a minor character is developed in a novella, portion 108 may include paragraphs from the first, fourth, and eighth chapters of the novella.

Request 110 may be generated by a user 102 to prompt server 106 to identify a collaborator 112 for portion 108. User 102 may transmit request 110 to server 106 through a Hypertext Transfer Protocol (HTTP) POST request, through an e-mail addressed to a predetermined e-mail address, using Asynchronous JavaScript and XML (Ajax) web development techniques, or using some other appropriate communications protocol. In certain embodiments, server 106 may provide user 102 with Javascript or other suitable computer code implementing a document editing application with a request feature. In such embodiments, the request feature may detect a predetermined sequence of user actions, which may include user 102 selecting a portion of document 104 with an on-screen cursor, selecting an on-screen menu option corresponding to making a request 110, or other suitable actions for user 102 to generate a request 110. The request feature may respond to the predetermined sequence of actions by generating an input window, in which user 102 may provide text explaining the nature of request 110. Such explanatory text may be provided by user 102 typing, by user 102 choosing from a list of keywords, or by some other appropriate method for user 102 providing explanatory text. The request feature may transmit the provided text to server 106 in response to detecting an end-of-input signal, such as a user 102 clicking on a submission button, a user 102 clicking outside the input window, a user 102 pressing a “return” key, or some other suitable indication that user 102 has prepared request 110.

Request 110 may include one or more keywords, sentences, or paragraphs elaborating the collaboration user 102 desires. Much as document 104 includes one or more document subject matters, the text of request 110 represents one or more request subject matters. A request subject matter is a subject matter on which the user 102 desires collaboration. As an illustrative example, a request 110 asking how Commodore Perry opened trade with Japan includes request subject matters of Commodore Perry and Japan. The request subject matter may be the same as or substantially similar to one or more document subject matters. In certain embodiments, the request subject matter may not be the same as the document subject matter, but may be based on one or more document subject matters. The request subject matter may be determined in similar ways to the document subject matter. In response to receiving a request 110, server 106 may contact one or more receiving collaborators 112a.

A receiving collaborator 112a may be a user of collaboration system 100 identified by server 106 as likely to provide useful collaboration related to request 110. To the extent that a receiving collaborator 112a has expertise in (i.e., is familiar with) such a relevant subject matter, the receiving collaborator 112a is likely to provide useful collaboration in response to request 110. Therefore, server 106 may identify a receiving collaborator 112a by identifying a user of collaboration system 100 with expertise in a subject matter of request 110. In certain embodiments, server 106 may also identify a receiving collaborator 112a by identifying a user of collaboration system 100 with expertise in a subject matter of the document 104 in which request 110 was made. As an illustrative example, a server 106 receiving a request 110 related to quantum mechanics in the context of a document 104 about Albert Einstein may contact a receiving collaborator 112a who has expertise in quantum mechanics, Einstein, or the history of science. In certain embodiments, there may be a different number of receiving collaborators 112a than are depicted. Areas of expertise may be user-provided, identified through the subject matter of other documents 104 associated with receiving collaborator 112a, or identified through some other suitable method. In certain embodiments, receiving collaborator 112a may also be identified by previous collaboration with a user 102, whether collaborator 112a is actively connected to server 106, membership in one or more groups 114 of users of collaboration system 100 associated with a user 102, or other suitable criteria. In certain embodiments, membership in a group 114 of a user 102 may be identified by the user 102, imported by the server from a social network website, which may include Google+, or professional network website, which may include LinkedIn, or by some other suitable method for identifying who is a member of a group 114 of user 102. Server 106 may contact receiving collaborator 112a with an instant message, a pop-up window, a text message, an email, or some other suitable communication. In certain embodiments, a receiving collaborator 112a may forward a message from server 106 to one or more indirect-contact collaborators 112b.

An indirect-contact collaborator 112b may be a person identified by at least one receiving collaborator 112a as being likely to help with request 110. As an illustrative example, if an art history student forwards a request 110 regarding Picasso to a colleague who is writing a dissertation on cubism, the first art history student may be a receiving collaborator 112a while the colleague may be an indirect-contact collaborator 112b. A receiving collaborator 112a may identify an indirect-contact collaborator 112b by providing server 106 with contact information for the indirect-contact collaborator 112b, by providing the indirect-contact collaborator 112b a link to request 110, or by some other suitable method for identifying the indirect-contact collaborator 112b. In certain embodiments, there may be a different number of indirect-contact collaborators 112b than are depicted.

Server 106 may also or alternatively contact an Internet collaborator 112c regarding request 110 through a message posted to a website 116, an Internet website suitable for disseminating a request, such as a social networking website, a professional networking website, a microblogging website, a question-and-answer website, or other suitable website. Server 106 posts the message, which may include content or a subject matter of request 110, and may indicate how the Internet collaborator 112c may respond to the request 110. Internet collaborator 112c may respond to the request by filling out an Internet form linked to in the message, by emailing a response to an email address provided in the message, by becoming a user of system 100 and responding in the same fashion as a receiving collaborator 112a, or by some other suitable method of responding. In certain embodiments, server 106 may retrieve a response posted by Internet collaborator 112c to the website 116. In certain embodiments, server 106 does not post the message to website 116 unless certain predetermined conditions have been met, such as at least one user 102 indicating that request 110 may be posted publicly, a predetermined length of time passing without server 106 receiving a response to the request 110, or some other suitable condition.

In response to receiving a request 110 associated with a document 104, server 106 may identify a candidate pool of at least one receiving collaborator 112a, which may include identifying a user of collaboration system 100 with expertise in a subject matter of document 104 or request 110 as described in relation to FIG. 2. In certain embodiments, the candidate pool may be restricted by membership in a group 114. Server 106 sends a message related to request 110 to at least one member of the candidate pool. In certain embodiments, the message may be forwarded to an indirect-contact collaborator 112b or posted on website 116. In response to at least one collaborator 112 responding to the message, which may include clicking a link, server 106 provides the at least one collaborator 112 with access to request 110 and at least portion 108 of document 104. Server 106 receives at least one response to the request from at least one collaborator 112, and provides the at least one response to the at least one user 102. In certain embodiments, server 106 provides the at least one response to the at least one user 102 by inserting the at least one response into document 104.

### Document Collaboration System

FIG. 2 is an illustrative block diagram of a collaborator identification and communication system 200. Referring to FIG. 1, system 200 transmits messages related to a request 110 between a user 102 and a collaborator 112. User 102 and collaborator 112 may connect to system 200 through a local area network, the Internet, or some other suitable computer connection. System 200 sends and receives data related to a document 104 through communications port 202. User database 204 stores user information, including which users 102 have permission to access or edit the document 104 and which subject matters a user 102 is familiar with. If a user 102 is authorized to access and edit a document 104, document engine 206 provides user 102 with the most recent document content available and records user-provided content in document database 208. Request identification processor 210 processes the document content to identify a user request 110, while natural language processor 212 processes the document content and identified requests to determine the document and request subject matters. Message processor 214 contacts at least one potential collaborator to solicit a response to a request 110, and may make further contact attempts based on the output of timer 216. In certain embodiments, the elements of system 200 may be implemented in circuitry on separate physical computing devices, such as servers, general purpose processors, mainframes, or clusters of computing devices, and coupled via a network.

Communications port 202 may be a network port that receives data from and transmits data to a user 102 and a collaborator 112, allowing system 200 to facilitate collaboration between the two. Data may include document content, a request 110, a response to a request 110, and other data related to document 104, and communications port 202 may be linked to the user 102 and the collaborator 112 through a network. Communications port 202 may be a 100BASE-TX port, a 1000BASE-T port, a 10GBASE-T port, or some other suitable network port. In certain embodiments, there may be a different number of ports than are depicted.

User database 204 may be a computer-readable and -writable medium storing information about a user of requesting system 200, which may include a list of subjects the user has expertise in, which groups 114 the user is a member of, and other identifying information that may be used to identify the user as a potential collaborator 112. In certain embodiments, user database 204 may include information rating the user as a collaborator 112, which may include how often the user has acted as a collaborator 112, how often other users have been satisfied with collaboration provided by the user, or other appropriate measures of how effective the user is as a collaborator 112. User database 204 further indicates which documents the user may access or edit through document engine 206.

Document engine 206 may be a computer processor that provides users of requesting system 200 access to document content and records changes or additions to document content in document database 208. In certain embodiments, document engine 206 may be a collaborative document editing system. Document engine 206 also relays document content to request identification processor 210 to identify a user request and to natural language processor 212 to identify at least one document subject matter. In response to at least one member of the candidate pool contacted by message processor 214 accessing a link, accepting a prompt, or otherwise indicating a willingness to review a request 110, document engine 206 allows the at least one member to access the request 110 and the portion 108 of document 104 related to the request 110, which are stored in document database 208.

Document database 208 may be a computer-readable and -writable medium storing documents and materials related to documents, including requests for collaboration and responses to requests. Document database 208 stores content of a document 104 provided by a user 102, and provides access to any user 102 authorized to access document 104. In some embodiments, a first user 102 may edit document 104 while a second user 102 is accessing document 104.

Request identification processor 210 may be a computer processor that identifies a request 110 within content submitted to document engine 206. Request identification processor 210 may identify a request 110 by searching content received by system 200 for a predetermined regular expression, an alphanumerical code associated with a request 110, or some other appropriate flag identifying content as a request 110. In certain alternate embodiments, request identification processor 210 may identify content received through a predetermined transfer protocol as a request 110. Such embodiments may include an e-mail sent to a predetermined e-mail address, an HTTP POST request including a predetermined request tag, or some other suitable transfer protocol. In response to identifying a request 110, request identification processor 210 sends the content of the request to natural language processor 212 to identify the request subject matter.

Natural language processor 212 may be a computer processor that determines the subject matters of a document 104 and a request 110. Natural language processor 212 may identify a subject matter of text as a key word or phrase, known as a token, of the text. Tokens may be identified by removing a predetermined set of words, which may include articles and prepositions, from the text, by comparing words to a dictionary to identify parts of speech and combine nouns or verbs with words modifying them, by searching for predetermined phrases within the text, or by some other suitable method of token identification. In certain embodiments, natural language processor 212 may refine a list of tokens according to the frequency of the tokens within the text, the frequency of the tokens within document database 208, or according to some other predetermined criteria. In certain embodiments, natural language processor 212 may identify a subject matter of non-text content of a document 104 by converting the non-text content into text and identifying a subject matter of the converted text as above. Images of text may be converted into text using optical character recognition, such as is described in U.S. Pat. No. 8,175,394, which is incorporated herein in entirety by reference. Text describing an image may be provided by searching an image database for a reference image similar to the image and providing a predetermined description associated with the reference image, or through some other suitable method for providing text describing an image. Spoken words may be converted into text through a speech recognition technique, which may include taking a series of time-windowed Fourier transforms of an audio recording and performing a statistical analysis of each Fourier transform to find which words have been spoken, or through some other suitable technique for transcribing a recording of spoken words. Similarly, text describing an audio file may be provided by searching a database of audio recordings for a reference sound with a similar time-windowed Fourier transform to a time-windowed Fourier transform of the audio file and providing a predetermined text associated with the reference sound, or through some other suitable method for providing text describing an audio file. In certain embodiments, natural language processor 212 may also or alternatively identify a subject matter of at least one of a document 104 or a request 110 through metadata provided by a user 102. Metadata may be data associated with but not included in the content of the document 104 or the request 110, and may indicate a subject matter associated with the document 104 or the request 110.

In certain embodiments, natural language processor 212 may also identify portion 108 of document 104 by identifying which content of document 104 includes a token matching at least one token of request 110. The subject matters identified by natural language processor 212 serve as a basis for message processor 214 identifying a candidate pool of receiving collaborators 112a.

Message processor 214 may be a computer processor for addressing, sending, and receiving messages related to request 110. To address a message related to request 110, message processor 214 may search user database 204 to identify a candidate pool of receiving collaborators 112a with expertise in at least one subject matter identified by natural language processor 212. Expertise may be identified by association with a predetermined number of documents 104 sharing the at least one subject matter, users who have responded to a previous request 110 associated with the at least one subject matter, or who are otherwise identified as familiar with the at least one subject matter in user database 204. In certain embodiments, the candidate pool may also include receiving collaborators 112a with expertise in at least one allied subject matter, a subject matter related to the at least one subject matter identified by natural language processor 212. As an illustrative example, a candidate pool to resolve a request 110 regarding epic poems may include a receiving collaborator 112a with expertise regarding Homer, Virgil, or John Milton. An allied subject matter may be a subject matter that is an expertise of at least a predetermined fraction of users with expertise in the at least one subject matter, a subject matter that is a document subject matter of at least a predetermined fraction of documents 104 with a document subject matter including the at least one subject matter, or a subject matter otherwise associated with the at least one subject matter. In certain embodiments, the candidate pool may also be restricted to users belonging to a group 114 of at least one user 102, to users with a similar collaborator rating as at least one user 102, or to users who meet some other appropriate identifying characteristic. One or more members of the candidate pool of receiving collaborators 112a may then be contacted.

Message processor 214 sends a message to at least one member of the candidate pool. The message relates to request 110, and may include at least one subject matter of document 104 or request 110, the content of request 110, or some other suitable indicator of why the at least one member of the candidate pool may be interested in responding to request 110. In certain embodiments, message processor 214 may also post the message to at least one Internet website to solicit responses from unidentified collaborators. In response to receiving a response to the message, message processor 214 determines routing information for the response, which may include which document 104 and request 110 the response relates to, and may be identified from a source of the response, a header of the response, or other suitable identifying information. Message processor 214 provides the response to user 102, which may include emailing the response to user 102, providing the response to document engine 206 to insert into document 104, or other suitable method of providing the response. In certain embodiments, message processor 214 may receive a user reply to a collaborator response, and provide the reply to at least one collaborator 112.

Timer 216 may be timing circuitry allowing requesting system 200 to take time-dependent actions, which may include waiting a predetermined amount of time before contacting a potential receiving collaborator 112a not in group 114, posting a message to website 116, or other suitable time-dependent action. Timer 216 may be a 555 timer integrated circuit, a software module implemented on a computer processor, or other suitable timing apparatus.

### Collaboration Interfaces

FIGS. 3A-F depict exemplary screenshots of the outside collaboration process in system 200. In particular, FIG. 3A depicts a screenshot of a user interface 300 in which a user is making a request 301, corresponding to request 110 of FIG. 1. FIG. 3B depicts a screenshot of the user interface 300 in which a second user is receiving an instant message 304 related to request 301. FIG. 3C depicts responding interface 310, in which a collaborator may make a response 305 to request 301. FIG. 3D depicts how the user may receive response 305, FIG. 3E depicts how the user may accept response 305, and FIG. 3F depicts how the user may reply to response 305 with a follow-up 307.

FIG. 3A depicts a screenshot of user interface 300 in which a user of system 100 requests collaboration by making request 301. The user is depicted as making request 301 by writing a predetermined text command and the substance of a request into a comment field. Referring to FIG. 2, request identification processor 210 may identify request 301 by the predetermined text command. In certain embodiments, request identification processor 210 may identify request 301 by receiving a designated request message, which the user may generate by creating a message in a field called up by selecting a menu option, by pressing a predetermined combination of keys, or by some other appropriate action. Natural language processor 212 determines one or more subject matters of the request 301 and a document 302 in which request 301 is made. Request 301 may relate to a portion 303 of document 302. In certain embodiments (not shown), request 301 may relate to several disconnected portions of document 302. Portion 303 may be determined by user selection, search by natural language processor 212 for content related to at least one subject matter of request 301, or by some other suitable method for identifying content related to request 301.

FIG. 3B depicts a screenshot of a receiving collaborator 112a receiving an instant message 304 relating to request 301 within user interface 300. The message asks whether the receiving collaborator 112a will consider responding to request 301, and in certain embodiments may include at least a portion of request 301. The message is depicted as an instant message 304, but in certain embodiments may be a pop-up window, an email, or another suitable alert. Receiving collaborator 112a may reject or accept instant message 304. In the former case, which in certain embodiments may be identified by receiving collaborator 112a not clicking on instant message 304 for a predetermined period of time, instant message 304 may disappear from user interface 300. In the latter case, which in certain embodiments may be identified by receiving collaborator 112a accessing a link by clicking on instant message 304, the receiving collaborator 112a will be presented with responding interface 310, depicted in FIG. 3C.

FIG. 3C depicts a screenshot of a responding interface 310, which is displayed in response to a receiving collaborator 112a accepting instant message 304. Responding interface 310 allows a user to respond to request 301, and provides the user with both request 301 and portion 303 to provide context in which to respond to request 301. Referring to FIG. 1, a user may compose a response 305, provide contact information for at least one indirect-contact collaborator 112b in forwarding field 306, or choose not to respond to request 301. Server 106 may transmit a response 305 as depicted in FIG. 3D. Server 106 may also transmit the information presented in responding interface 310 to the contact provided in forwarding field 306. Responding interface 310 may be a Javascript interface, a web form, or other medium suitable for relating request 301 and portion 303 and allowing a user to create a response 305.

FIG. 3D depicts a screenshot of user interface 300 in which server 106 has inserted response 305 into document 302 by appended response 305 to request 301. Response 305 may have been generated by a receiving collaborator 112a or by some other collaborator 112. The depicted response 305 is distinguished from other content of document 302 by a text heading. In certain embodiments, response 305 may not be identified, or may be identified by color-coding or other suitable means of distinguishing response 305 from other elements of document 302. In certain embodiments, response 305 may be provided outside of document 302, including by email, instant message, pop-up window, or some other suitable method for conveying response 305. As depicted in FIG. 4, a user may reject, accept, or reply to response 305. In the former case, server 106 may allow a second collaborator 112 to provide a second response 305. The latter two options are described with respect to FIG. 3E and FIG. 3F.

FIG. 3E depicts a screenshot of user interface 300 in which a user has accepted response 305. Response 305 may remain in document 302, but server 106 may close request 301, rescinding access to any part of document 302 by a collaborator 112 and thereby preventing one or more collaborators 112 from viewing or responding to request 301 or document 302.

FIG. 3F depicts a screenshot of user interface 300 in which a user has made a follow-up 307 to response 305. Follow-up 307 may include a question, clarifying statement, or other message, and may be sent to a collaborator 112 who generated response 305. In some embodiments, follow-up 307 may also or alternatively be provided to a second collaborator 112 by including follow-up 307 in responding interface 310.

### Third-Party Collaboration Process

FIG. 4 is an illustrative flow chart of a process 400 for third-party collaboration on a document. Referring to FIG. 1, process 400 begins with step 401, in which server 106 receives a request 110. Referring to FIG. 2, in step 402 the request identification processor 210 identifies the request 110 and forwards request 110 to natural language processor 212. As described in relation to FIG. 2, natural language processor 212 identifies at least one subject matter of request 110 and the document 104 in which request 110 was made, and the portion 108 to which request 110 relates is identified as well. Steps 401 and 402 thus prepare process 400 to identify and contact potential collaborators, which begins with step 403.

Step 403 identifies a candidate pool of at least one receiving collaborator 112a. The candidate pool is identified from the user database 204 on the basis of familiarity in at least one subject matter identified in step 402, as described in relation to FIG. 2. The candidate pool may further be identified on a basis of previous collaboration with at least one user 102, by an indicator of whether a candidate is connected to server 106, by membership in a group 114 of at least one user 102, or through other suitable criteria for identifying a receiving collaborator 112a. In certain embodiments, step 403 may also identify a website 116 on which to solicit the assistance of an Internet collaborator 112c. In step 404, message processor 214 sends a message requesting a response to request 110 to at least one member of the candidate pool identified in step 403. In certain embodiments, the message may be generated by combining at least one set phrase and at least one subject matter identified in step 402. In response to at least one collaborator 112 responding to the message of step 404 as described in relation to FIG. 3B, step 405 provides the at least one collaborator 112 with the request 110 and the portion 108, as described in relation to FIG. 3C. In certain embodiments, if a collaborator 112 then provides contact information for an indirect-contact collaborator 112b, message processor 214 will add the indirect-contact collaborator 112b to the candidate pool and third-party collaboration process 400 will return to step 403. To improve the probability of receiving a response 305, step 406 determines if a collaborator 112 has provided a response 305 within a predetermined amount of time. If not, third-party collaboration process 400 returns to step 403. In certain embodiments, the candidate pool may be broadened in response to third-party collaboration process 400 returning to step 403, such as by including users familiar with subjects related to at least one subject matter of document 104 and request 110, by including users not in group 114, or by otherwise loosening the restrictions on the candidate pool.

If third-party collaboration process 400 receives a response 305, step 407 provides response 305 to at least one user 102, which may include inserting response 305 in document 104 as described in relation to FIG. 3D, sending response 305 to user 102 by email or instant message, or providing response 305 to at least one user 102 through some other suitable method. Step 408 receives a reaction to response 305 from at least one user 102. As depicted in FIG. 3D, the at least one user 102 may indicate whether response 305 resolved request 110, and may make a follow-up 307. In certain embodiments, if no reaction is received within a predetermined amount of time, process 400 may proceed to step 412.

In response to server 106 receiving a reaction in step 408, step 409 determines whether the at least one user 102 has made a follow-up 307. If so, step 410 transmits the follow-up 307 to the at least one responding collaborator 112 and returns to step 406 to receive a response to the follow-up 307. In certain embodiments, step 410 may also provide response 305 and follow-up 307 to at least one other collaborator 112 to clarify the original request 110. But if the at least one user 102 did not make a follow-up 307, process 400 continues to step 411, which determines whether the at least one user 102 indicated that response 305 resolved request 110. If not, process 400 returns to step 406 to receive a second response 305 that may meet request 110. If the at least one user 102 is satisfied, step 412 may amend user database 204 to prevent further access of request 110 or portion 108 by a collaborator 112, ending process 400. In certain embodiments, collaborator access to any portion of document 104 may also be rescinded after a predetermined length of time or in response to an action by at least one user 102. As an illustrative example, if request 110 is unanswered for a week, or if the at least one user 102 deletes request 110, process 400 may proceed to step 412. In certain embodiments, the satisfaction or lack thereof of the at least one user 102 may be used to adjust a rating of the at least one responding collaborator 112, as described in relation to FIG. 2.

### Computing Device

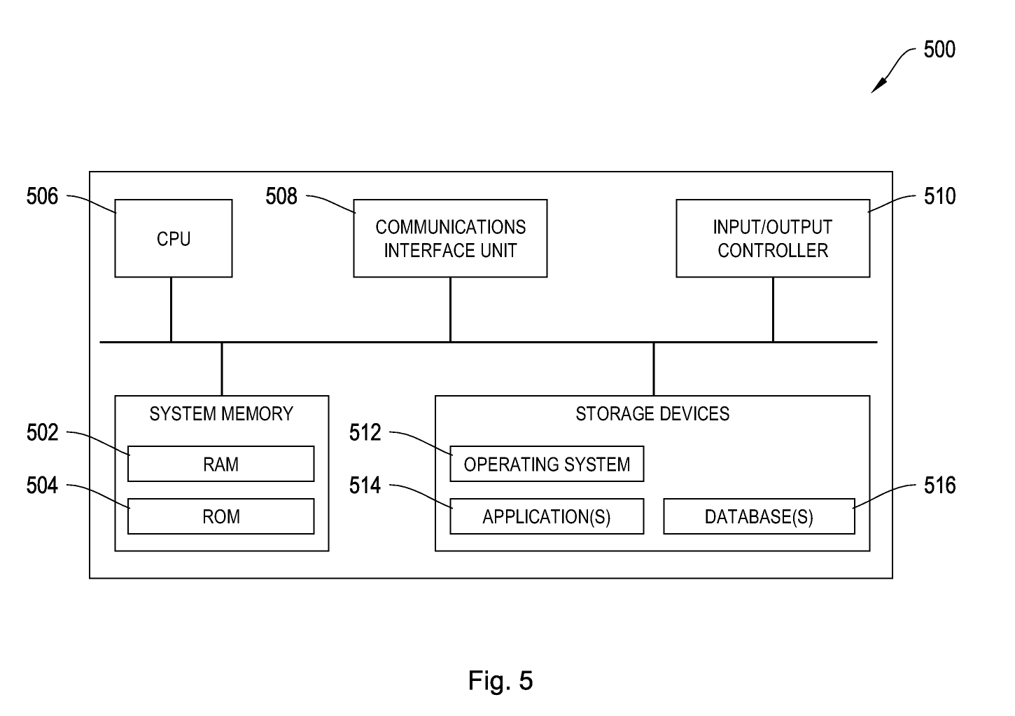

FIG. 5 is a block diagram of a computing device that can be used to implement or support the any of the components of the system of FIG. 1, and for performing any of the processes described herein. Server 106 may be implemented on one or more computing devices 500 having suitable circuitry, and a user 102 and a collaborator 112 may communicate with server 106 through one or more computing devices 500 having suitable circuitry. In certain aspects, a plurality of the components of system 100 may be included within one computing device 500. In certain implementations, a component and a storage device may be implemented across several computing devices 500.

The computing device 500 comprises at least one communications interface unit, an input/output controller 510, system memory, and one or more data storage devices. This can support a communications port such as communications port 202 of FIG. 2. The system memory includes at least one random access memory (RAM 502) and at least one read-only memory (ROM 504). The memory 504 can support the user database of FIG. 2, for example. All of these elements are in communication with a central processing unit (CPU 506) to facilitate the operation of the computing device 500. The computing device 500 may be configured in many different ways. For example, the computing device 500 may be a conventional standalone computer or alternatively, the functions of computing device 500 may be distributed across multiple computer systems and architectures. In FIG. 5, the computing device 500 is linked, via network or local network, to other servers or systems.

The computing device 500 may be configured in a distributed architecture, wherein databases and processors are housed in separate units or locations. Some units perform primary processing functions and contain at a minimum a general controller or a processor and a system memory. In distributed architecture implementations, each of these units may be attached via the communications interface unit 508 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 506 comprises a processor, such as one or more conventional microprocessors and one or more supplementary co-processors such as math co-processors for offloading workload from the CPU 506. CPU 506 The CPU 506 is in communication with the communications interface unit 508 and the input/output controller 510, through which the CPU 506 communicates with other devices such as other servers, user terminals, or devices. The communications interface unit 508 and the input/output controller 510 may include multiple communication channels for simultaneous communication with, for example, other processors, servers or client terminals.

The CPU 506 is also in communication with the data storage device. The data storage device may comprise an appropriate combination of magnetic, optical or semiconductor memory, and may include, for example, RAM 502, ROM 504, flash drive, an optical disc such as a compact disc or a hard disk or drive. The CPU 506 and the data storage device each may be, for example, located entirely within a single computer or other computing device; or connected to each other by a communication medium, such as a USB port, serial port cable, a coaxial cable, an Ethernet cable, a telephone line, a radio frequency transceiver or other similar wireless or wired medium or combination of the foregoing. For example, the CPU 506 may be connected to the data storage device via the communications interface unit 508. The CPU 506 may be configured to perform one or more particular processing functions.

The data storage device may store, for example, (i) an operating system 512 for the computing device 500; (ii) one or more applications 514 (e.g., computer program code or a computer program product) adapted to direct the CPU 506 in accordance with the systems and methods described here, and particularly in accordance with the processes described in detail with regard to the CPU 506; or (iii) database(s) 516 adapted to store information that may be utilized to store information required by the program. The depicted database 516 can be any suitable database system, including the commercially available Microsoft Access database, and can be a local or distributed database system. The design and development of suitable database systems are described in McGovern et al., A Guide To Sybase and SQL Server, Addison-Wesley (1993).

The operating system 512 and applications 514 may be stored, for example, in a compressed, an uncompiled and an encrypted format, and may include computer program code. The instructions of the program may be read into a main memory of the processor from a computer-readable medium other than the data storage device, such as from the ROM 504 or from the RAM 502. While execution of sequences of instructions in the program causes the CPU 506 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to facilitating collaboration as described herein. The program also may include program elements such as an operating system 512, a database management system and “device drivers” that allow the processor to interface with computer peripheral devices (e.g., a video display, a keyboard, a computer mouse, etc.) via the input/output controller 510.

The term “computer-readable medium” as used herein refers to any non-transitory medium that provides or participates in providing instructions to the processor of the computing device 500 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 506 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device 500 (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

As discussed above, a function relating to facilitating collaboration can be realized as a software component operating on a conventional data processing system such as a Unix workstation. In that embodiment, the function can be implemented as a C language computer program, or a computer program written in any high level language including C++, Fortran, Java or BASIC. See The C++ Programming Language, 2nd Ed., Stroustrup Addision-Wesley. Additionally, in an embodiment where microcontrollers or DSPs are employed, the function relating to facilitating collaboration can be realized as a computer program written in microcode or written in a high level language and compiled down to microcode that can be executed on the platform employed. The development of such network traffic control systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing. Developing code for the DSP and microcontroller systems follows from principles well known in the art.

Some embodiments of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some embodiments include a computer program product comprising a computer readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some embodiments different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

### Alternative Embodiments

While various embodiments of the present disclosure have been shown and described herein, it will be obvious to those skilled in the art that such embodiments are provided by way of example only. Numerous variations, changes, and substitutions will now occur to those skilled in the art without departing from the disclosure. For example, a document may be a spreadsheet, presentation, drawing, video, or audio track; a request may ask for help with writing style, and a collaborator may be chosen on the basis of stylistic ability; or a user may pay a fee to request collaboration with highly rated collaborators. It should be understood that various alternatives to the embodiments of the disclosure described herein may be employed in practicing the disclosure. It is intended that the following claims define the scope of the disclosure and that methods and structures within the scope of these claims and their equivalents be covered thereby.

1. A method of online document collaboration, comprising:
providing, at a server, a document generated by at least one user and having content including a document subject matter;
receiving, at the server, a request from the at least one user, the request having a request subject matter;
identifying, at the server, at least one of the document subject matter and the request subject matter;
identifying, at the server, a candidate pool of at least one receiving collaborator based on at least one of the request subject matter and the document subject matter;
sending, by the server, to at least one receiving collaborator in the candidate pool a message related to the request;
granting, by the server, collaborator access to a portion of the document in response to a responding collaborator responding to the message;
sending, by the server and to the responding collaborator, a responding interface including the request and a response field for receiving a response from the responding collaborator;
receiving, at the server and from the responding interface, the response to the request; and
sending, by the server, the response to the at least one user.

2. The method of claim 1, wherein identification information for the candidate pool of collaborators is received from the at least one user.

3. The method of claim 1, wherein the candidate pool of collaborators are members of a group of the at least one user.

4. The method of claim 1, wherein a responding collaborator is a receiving collaborator.

5. The method of claim 1, wherein the responding collaborator is outside the candidate pool.

6. The method of claim 1, further comprising receiving, at the server, a user rating of the response.

7. The method of claim 6, wherein the candidate pool of collaborators is determined by the ratings the user has received for a response.

8. The method of claim 1, wherein identifying the candidate pool includes comparing at least one of the document subject matter and the request subject matter with one or more documents generated by one or more collaborators.

9. The method of claim 1, wherein the message sent to the at least one receiving collaborator in the candidate pool includes the user request.

10. The method of claim 1, wherein sending the response to the user includes embedding the response within the document and providing the document to the user.

11. The method of claim 1, further comprising rescinding, by the server, collaborator access to the document.

12. A system of online document collaboration, comprising:
a user database having circuitry for storing at least one user permitted to edit a document;
a document engine having circuitry for displaying a content of the document;
a document database having circuitry for storing the document content and a document subject matter associated with the document;
a request identification processor having circuitry for identifying a user request for collaboration and a portion of the document associated with the request;
a natural language processor having circuitry for identifying the document subject matter and a request subject matter associated with the request;
a message processor having circuitry configured for:
identifying a candidate pool of at least one receiving collaborator based on at least one of the request subject matter and the document subject matter;
generating a message related to the request;
sending the message to at least one receiving collaborator in the candidate pool;
granting at least one responding collaborator access to the identified portion of the document in response to the responding collaborator responding to the message;
sending, by the server and to the responding collaborator, a responding interface including the request and a response field for receiving a response from the responding collaborator;
receiving the response from the responding interface; and
providing the response to the requesting user.

13. The system of claim 12, wherein the user database is further configured to store expertise of a user in a subject matter.

14. The system of claim 13, wherein expertise in a subject matter is determined by a subject matter of a document the user is authorized to edit.

15. The system of claim 12, wherein the user database is further configured to store a user membership in a group.

16. The system of claim 15, wherein the message processor is further configured to identify the candidate pool of at least one receiving collaborator by membership in at least one group of at least one user permitted to edit the document.

17. The system of claim 12, wherein the user database is further configured to store a collaborator rating.

18. The system of claim 17, wherein the message processor is further configured to change a collaborator rating based on a user reply to the collaborator response.

19. The system of claim 17, wherein the message processor is further configured to identify the candidate pool of at least one receiving collaborator by collaborator rating.

20. The system of claim 12, wherein the response to the user is provided by embedding the response within the document.

21. (canceled)

22. The system of claim 12, wherein the message processor is further configured to rescind collaborator access in response to the passage of a predetermined length of time.

23. The system of claim 12, wherein the request identification processor is further configured to rescind collaborator access in response to a user action.

24. The method of claim 1, wherein identifying, at the server, a candidate pool of at least one receiving collaborator is based on the request subject matter and the document subject matter.
